(19) United States
(12) Patent Application Publication
(10) Pub. No.: US 2008/0057263 A1
(43) Pub. Date: Mar. 6, 2008

(54) Fibrous pad structure having a variable density

(75) Inventor: Tomas Jung-Fu Chien, Montebello, CA (US)

Correspondence Address: HAMRE, SCHUMANN, MUELLER & LARSON, P.C., P.O. BOX 2902, MINNEAPOLIS, MN, 55402-0902, US

(73) Assignee: SHINIH ENTERPRISE CO., LTD., PanChiao City (TW)

(21) Appl. No.: 11/516,122

(22) Filed: Sep. 6, 2006

(51) Int. Cl. B32B 5/00; B32B 5/12

(52) U.S. Cl. 428/98; 428/105; 428/107; 428/113; 428/114

(57) ABSTRACT

The present invention relates to a fibrous pad structure having a variable density. The continuous strip-shaped webs are sliced and rubbed to form one or more continuous strip-shaped webs that are separated from each other by a constant distance. The strip-shaped webs can also be spread and lapped onto a continuous smooth fibrous web in a regular arrangement. The combined fibrous webs are corrugated and shaped into a vertical porous fibrous pad. Such a fibrous pad has a different density distribution in the transversal cross section and a continuous corrugated structure in the mechanical direction. The density of the combined fibrous pad in accordance with the present application can be adjusted according to the uses of the fibrous pad. The mechanical properties of the products made from the fibrous pad thus are adjustable to meet the requirements of different uses of the product.

### BACKGROUND OF THE INVENTION

1. Field of the Invention

The present application relates to a fibrous pad with a variable density, in particular to a material for filtering gas or liquid, to a backing material for protection and packaging, or a backing material having air permeability.

2. Description of Related Art

The applicant filed U.S. patent application Ser. No. 548,259, titled “Method for producing a variable density, corrugated resin-bonded or thermo-bonded fiberfill and the structure produced thereby” with the U.S. Patent and Trademark Office. The patent application was granted U.S. Pat. No. 5,702,801 and discloses a vertical corrugated fiberfill structure. At least one smooth fibrous web is repeatedly folded in a lapping manner to form upper and lower corrugated surfaces by using a vertical corrugated fiberfill forming machine. The distances between the upper and lower corrugated surfaces define the thickness of the corrugated fiberfill structure. The density of the fibrous web structure varies across the thickness of the structure. FIG. 1 is a cross-sectional view showing the structure of a corrugated fiberfill 102 of one embodiment in said U.S. patent application in the mechanical (longitudinal) direction. As illustrated by the three smooth fibrous webs constituting the corrugated fiberfill 102, a low-density layer 104, a medium-density layer 106 and a high-density layer 108 are arranged from top to bottom along the thickness of the corrugated fiberfill. With the layers having different densities in such an arrangement, the structure of the fibrous pad is formed to comprise a soft contacting top surface (low-density layer) and a bottom layer (high-density layer) having high supporting strength.

As described in foregoing prior art, the fibrous web is repeatedly folded to form a continuous multi-layered corrugation in the mechanical direction. The density of the corrugated fiberfill structure varies across the thickness of the structure (in the vertical direction). When used as a backing material, the structure of the fibrous pad provides a surface layer that is soft and air permeable and a bottom layer having high supporting strength. The density of the fiberfill structure varies across the thickness in the vertical direction, and thus the structure provides a comfortable and stable function for sitting. The fiberfill structure is formed by folding the smooth fibrous web(s), and layers having different densities are arranged in a lapping manner along the vertical direction. Consequently, the low-density layer, the medium-density layer and the high-density layer are cross-lapped in the vertical direction. The air permeability and the water permeability of the fiberfill structure are not good enough for a filtering material. The uses of the application of the prior art are thus limited.

Moreover, the applicant had filed Taiwan Patent Application No. 090220142, titled “air permeable porous fibrous pad,” with the Taiwan Intellectual Property Office. The patent application was granted Utility Model Patent Publication No. 582,404 and was published on Apr. 1, 2004. This patent application disclosed an air permeable porous fibrous pad and a method for forming the same. In this patent application, a single-layered or multi-layered fibrous web is cut into long-strip fibrous webs by means of at least two sets of belt slicers. The strip-shaped fibrous webs cut by the slicers are separated and in parallel relation with respect to each other. At least two sets of rollers having adjustable axes are used to adjust the relative positions of the strip-shaped fibrous webs such that the parallel long-strip fibrous webs are combined and overlap one another. The overlapped fibrous webs are then transported into a cross-lapper to obtain a porous fibrous pad having air permeability.

The applicant of the present application practiced the prior art described above and found drawbacks to the prior art. The strip-shaped fibrous webs are cut by slicers to become continuous and separated double or multiple-double layers. The strip-shaped fibrous webs are folded in parallel and combined to be a continuous and separated strip-shaped fibrous web. No cross-holding force exists between the continuous strip-shaped fibrous webs. Therefore, in manufacturing the fibrous webs by using the forming machine, the longitudinal and transversal tensions in the fibrous webs are insufficient to prevent the fibrous webs from sticking together by the fibers at the two sides. It is difficult to operate the machine when forming the fibrous webs. Consequently, the size of the fibrous webs being formed is not constant because of the difficulty in operation. Moreover, the cut strip-shaped fibrous webs are folded in parallel and combined to obtain continuous and spaced fibrous webs, and the fibrous webs are then formed by cross-lappers. The fibers of the fibrous webs lapped in parallel with respect to each other by the cross-lapper are arranged to be parallel. The lapped fibrous webs have air-permeable pores. However, when being used as a backing material, the density of the fibers is so small in the direction of applied forces that the fibrous webs cannot provide sufficient support. Consequently, the expansibility of the fibers is also insufficient to provide comfort and adequate support for the person sitting on the fibrous pad. In addition, the laminated fibrous webs obtained by folding the continuous strip-shaped fibrous webs in parallel comprise air-permeable pores. However, such fibrous webs are only suitable for porous seat cushions and mattresses, but not for the material for filtering gas or liquid since the through-hole structure of the fibrous webs cannot provide the corresponding functions for such uses.

In addition, in the related prior art, the disclosure of U.S. Pat. No. 3,615,989 titled “Nonwoven fabric structure” relates to a method of opening fibers for long strips to form continuous fibrous webs in parallel with respect to each other. The long-strip fibrous webs are cross-lapped to form multi-layered fibrous webs, in which the continuous filaments in each of the layers are arranged in parallel with respect to each other, and are arranged angularly with respect to the filaments in the immediately adjoining layers. The cross-lapped fibrous webs of lower-melt short-staple fiber are added onto the layers of cross-lapped long-strip fibrous webs, followed by needle punching and thermal bonding of the combined layers to form a nonwoven fabric backing material.

In the foregoing patent applications, the long-strip fibrous webs are cross-lapped after opening the fibers, and the continuous filaments in each layer of the fibrous webs are parallel with each other. Therefore, when the long-staple fibrous webs parallel with each other are cross-lapped on one another to form multi-layered fibrous webs, the pores formed by the cross-lapped continuous filaments are randomly distributed. The pores formed in the cross-lapped multi-layered fibrous webs are interlaced. The air permeability of the fibrous webs is not good enough. Therefore, when applying the fibrous webs to a seat cushion, the air permeability on the surface of the seat cushion is insufficient to provide adequate comfort to the person sitting on the backing material. When using the fibrous webs as a filtering material, the pores in the cross-lapped multi-layered fibrous webs are interlaced, and thus the material does not have a larger filtering area and thus cannot provide a sufficient filtering effect. Further, since the densities of the multi-layered fibrous webs are consistent throughout the structure, the fibrous webs do not have a supporting structure similar to multi-layered fibrous webs. Therefore, such fibrous webs cannot be applied to filtering and/or backing materials requiring fastening support.

### SUMMARY OF THE INVENTION

In view of foregoing drawbacks of the prior art, the primary objective of the present application is to provide a fibrous pad structure with a variable density obtained by different density combinations. A smooth fibrous web is sliced and cut into a specified width and then rubbed, or lengthwise strips of smooth fibrous web is drawn in using a strip-sucking device, forming continuous strip-shaped webs that are separated from each other. The strip-shaped webs having the specific width are then lapped in parallel with respect to each other or are not lapped to form one or more layers stacked together to obtain the high-density structure in the configuration of a fibrous web. Thereafter, the lapped strip-shaped webs are arranged in a regular manner to form a continuous arrangement of straight lines or S-curves. The lapped strip-shaped webs may also be arranged one above the other and displaced in a reciprocating motion with respect to each other to form an “8”-shaped or diamond-like pattern. The strip-shaped webs can also be arranged one above the other and displaced in a reciprocal motion with equal or unequal amplitude to form a cross-lapping arrangement with regular or irregular curves. The strip-shaped webs arranged in the regular manner are then spread on at least one continuous and smooth fibrous web to form a combination of fibrous webs. Thereafter, the combined fibrous webs pass through a vertical corrugation-forming machine to corrugate and shape the combined fibrous webs to obtain a vertical fiberfill structure. Such a vertical fiberfill structure comprises various density combinations and distributions in the cross direction and is continuously corrugated in the mechanical direction. The width of the strip-shaped webs can be chosen when manufacturing the fibrous webs on the basis of use. For example, when the fibrous pad is used as a filtering material, the width of the strip-shaped web is decreased to minimize the high-density layers in the transversal position of the fibrous pad. The high-density layers only provide the reinforcement for a general configuration. The low-density layers for filtering are maximized to increase the porous area and decrease the pressure drop. In contrast, when the fibrous pad is used as a backing material for protection and packaging, the width of the strip-shaped web should be increased to maximize the high-density layers to generally increase the supporting strength of the fibrous pad. The width of the low-density layer is minimized for air permeability or structural functions.

In the present application, in the structure of the formed corrugated fibrous webs, the high-density layers provide the function of supporting the structure and the low-density layers provide the functions of air permeability and sizing the whole structure by means of the regular and repeated distribution of the densities. The proportions of the high-density and low-density layers can be adjusted in manufacturing the fibrous pad in accordance with the practical applications to change the mechanical properties, such as the compression resistance and the air permeability, to achieve the best results for the uses of the fibrous pad. Therefore, in addition to a backing material having air permeability or a backing material for packaging having good supporting strength, the fibrous pad of this invention can also be used as a material for filtering gas or liquid. Therefore, the fibrous pad in accordance with the present application can be widely used in various applications.

Moreover, in the present invention, each of the strip-shaped webs can be rubbed and shaped into oblate webs. Therefore, the tension in each of the strip-shaped webs in the longitudinal direction is effectively increased and the fibrous webs do not stick together when being formed. Also, in the present invention, the tensions in the formed fibrous pad in the transversal direction are increased since the sliced strip-shaped webs may be spread onto a smooth fibrous web. Consequently, the fibrous webs will not be torn apart by applied external forces. The holding strength of the fibrous web is increased. The sizes of the whole fibrous pad are more stable. The drawbacks of the conventional techniques are thus overcome.

### BRIEF DESCRIPTION OF THE DRAWINGS

FIG. 1 is a cross sectional view showing the structure of the prior art;

FIG. 2A is a schematic flow chart illustrating the manufacturing process in accordance with the present application;

FIG. 2B is a schematic flow chart illustrating the manufacturing process using the strip-sucking device;

FIG. 3 is a schematic plan view showing the transversal friction conveying belt device for forming the oblate fibrous webs in accordance with the present application;

FIG. 4 is a cross sectional view of the rubbed strip-shaped webs in accordance with the present application;

FIG. 5 is a schematic view showing a single reciprocating device in accordance with the present application;

FIG. 6 is a schematic view showing the reciprocating devices arranged side-by-side in accordance with the present application;

FIG. 7 is a schematic view showing the reciprocating devices arranged side-by-side driven by the two motors in accordance with the present application;

FIG. 8 is a schematic perspective view showing the strip-shaped webs spread and folded along a straight line and the corrugated forming machine in accordance with the present application;

FIG. 9 is a perspective view showing the strip-shaped webs arranged along a straight line in accordance with the present application;

FIG. 10 is a schematic perspective view showing the strip-shaped webs spread and folded in an S-curve and the corrugated forming machine in accordance with the present application;

FIG. 11 is a perspective view showing the strip-shaped webs spread and folded in an S-curve in accordance with the present application;

FIG. 12 is a schematic perspective view showing the strip-shaped webs spread and folded in an “8”-shaped pattern and the corrugated forming machine in accordance with the present application;

FIG. 13 is a perspective view showing the strip-shaped webs spread and folded in an “8”-shaped pattern in accordance with the present application;

FIG. 14 is a schematic perspective view showing the strip-shaped webs spread and folded in a diamond-like pattern and the corrugated forming machine in accordance with the present application;

FIG. 15 is a perspective view showing the strip-shaped webs spread and folded in a diamond-like pattern in accordance with the present application;

FIG. 16 is a schematic perspective view showing the cross-lapped strip-shaped webs with regular curves and the corrugated forming machine in accordance with the present application;

FIG. 17 is a perspective view showing the cross-lapped strip-shaped webs with regular curves in accordance with the present application;

FIG. 18 is a schematic perspective view showing the cross-lapped strip-shaped webs with irregular curves and the corrugated forming machine in accordance with the present application;

FIG. 19 is a perspective view showing the cross-lapped strip-shaped webs with irregular curves in accordance with the present application;

FIG. 20 is a first schematic view showing the density of the transversal structure in the fibrous pad in accordance with the present application; and

FIG. 21 is a second schematic view showing the density of the transversal structure in the fibrous pad in accordance with the present application.

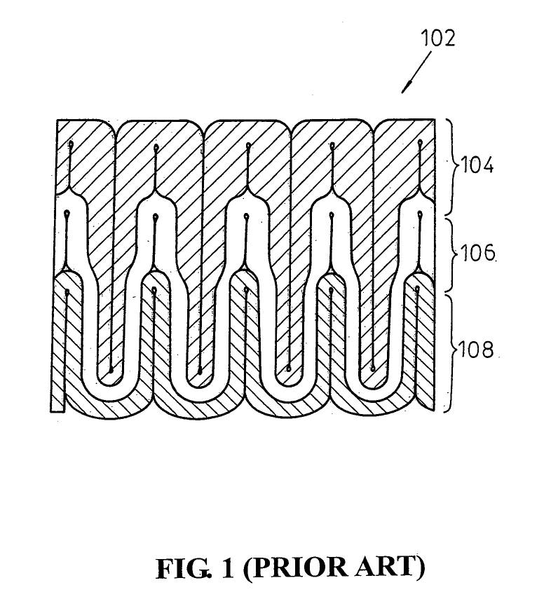

### DETAILED DESCRIPTION OF THE PREFERRED EMBODIMENT

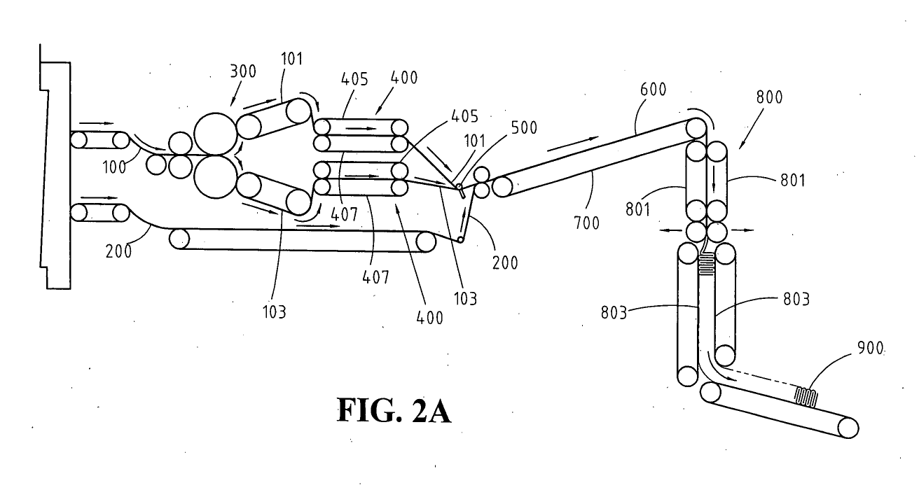

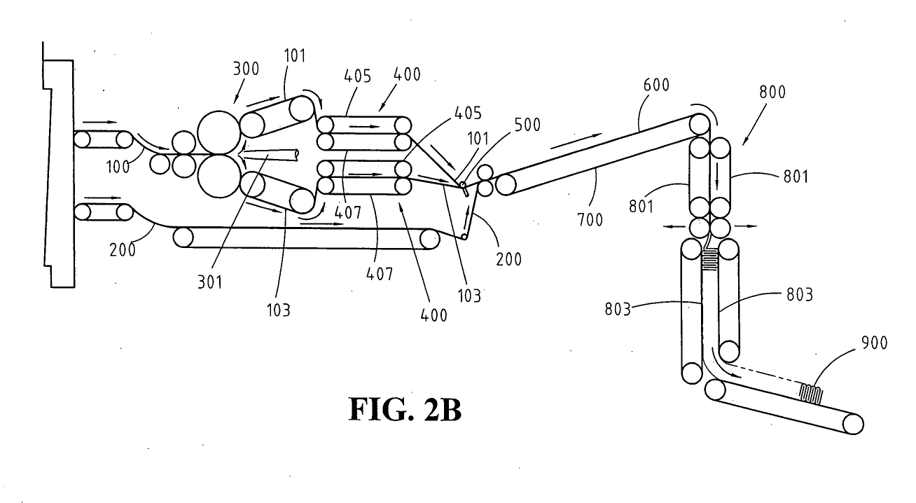

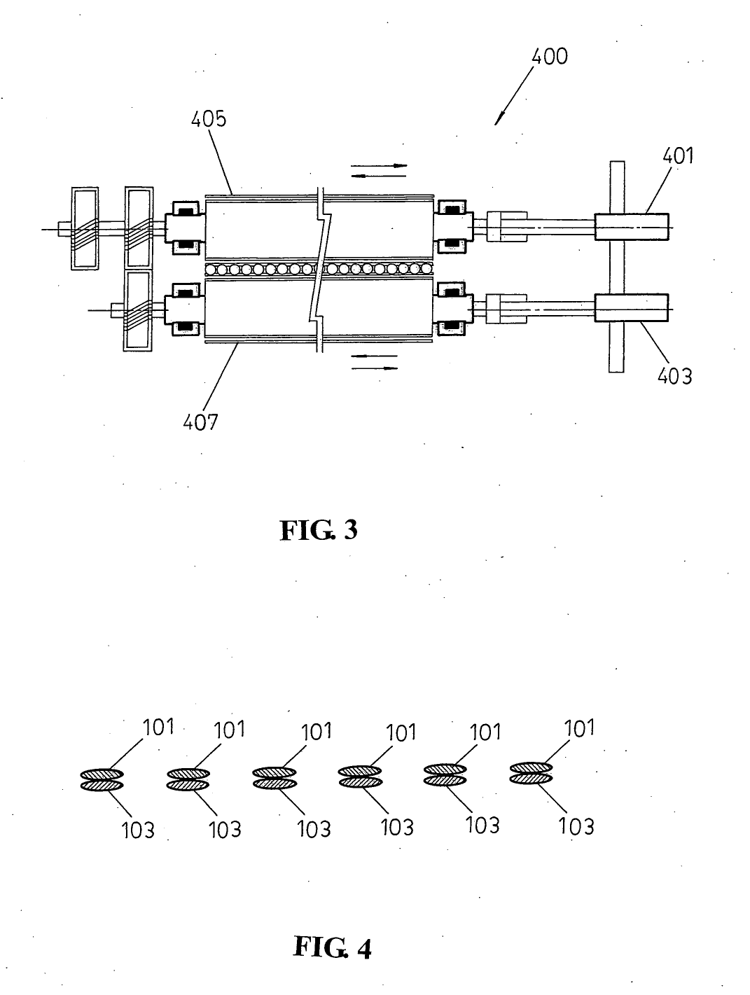

FIGS. 2 to 4 show the fibrous webs structure having a variable density in accordance with the present application. A process for manufacturing a fibrous pad in a preferred embodiment is shown and described. Two continuous and smooth single-layered fibrous webs 100 and 200 are carded by means of different carding machines or the same carding machine. The smooth upper fibrous web 100 is sliced in a regular manner by a slicer 300 (refer to FIG. 2A) or through the use of a strip-sucking device 301 installed in the rear of the upper fibrous web 100 conveyer (refer to FIG. 2B) that creates air pressure to suck the specified parts of the web 100 in a lengthwise direction. Both methods will yield two continuous strip-shaped webs 101 and 103. The two strip-shaped webs 101 and 103 are separated from each other by a constant distance. The upper and lower strip-shaped webs 101 and 103 are separated to form a fibrous web with upper and lower layers, and the strips on the layers remain at a constant distance from each other. The width of the strip-shaped webs 101 and 103 and the distance between the strip-shaped webs 101 and 103 are defined by the slicer 300 or by the quantity of the lengthwise strips that have been drawn in by the strip-sucking device 301, which further influences the variation in the density of the fibrous pad structure. The density variation and the influence on the density of the fibrous pad will be further described below. In addition, the slicer 300 can be provided with one or more stands to slice double- or multi-double-layered continuous fibrous strips to meet the requirements of the lapped webs and the width of the fibrous webs. The upper and lower strip-shaped webs 101 and 103 sliced by the slicer are then passed through the upper and lower conveyors 400 having a transversal friction belt. The configurations of the conveyors 400 are depicted in the front view of FIG. 3. When the sliced strip-shaped web 103 is fed along the mechanical direction, the rubbing wheel belts 405 and 407 driven by upper and lower eccentric discs 401 and 403 are primarily utilized to apply a reciprocally rubbing motion to the sliced strip-shaped web 103 in the corresponding transversal direction (indicated by the upper and lower arrows in FIG. 3). The elliptical strip-shaped webs 101 and 103 having a smaller diameter (the cross sections of the webs are shown in FIG. 4) are thus obtained. Subsequently, the two rubbed strip-shaped webs 101 and 103 are conveyed to a reciprocating device 500 to cross-lap or not cross-lap the separated upper and lower strip-shaped webs 101 and 103 in parallel with respect to each other. By means of the reciprocating motion of the reciprocating device 500, the strip-shaped webs 101 and 103 can be overlapped along the mechanical direction to form a pattern consisting of straight lines, S-curves, “8”-shaped patterns or diamond-like patterns, or different curviform cross-lapping patterns. Further, the strip-shaped webs 101 and 103 overlapped in parallel with respect to each other are combined with the continuous smooth fibrous web 200 below to obtain a combined fibrous web 600. The fibrous web 600 is then fed into a vertical corrugated fiberfill forming machine 800 by a conveying belt 700. One pair of reciprocating conveying belts 801 is utilized to continuously corrugate the combined fibrous web 600 in the vertical direction. The reciprocating conveying belts 801 are disposed adjacently and in parallel with respect to each other. The combined fibrous web 600 is further delivered into a conveying tunnel 803 that can control the corrugated thickness of the combined fibrous web 600 to form a fibrous pad 900 having a structure of multiple densities. The fibrous pad 900 has structural forces in the longitudinal, transversal and vertical directions, and different densities are distributed along the cross section of the fibrous pad. The porous fibrous pad 900 having multiple densities obtained by the process described above can further be processed by needle punching, stitch bonding, thermo bonding, water entanglement, or resin or heat-melted bonding to have good air permeability and structural strength, so as to be applied to fibrous pad products such as the backing material for protection and the filtering material having air and/or water permeability.

Still referring to FIGS. 2 to 4, the rubbing wheel belts 405 and 407 driven by upper and lower eccentric discs 401 and 403 displace the sliced strip-shaped webs 101 and 103 relative to each other in the transversal direction (as shown in FIG. 3) when the sliced strip-shaped webs 101 and 103 are passing through a pair of transversal friction conveying belt devices 400. The strip-shaped webs 101 and 103 are then rubbed in the transversal direction while being fed along the mechanical direction. The sliced strip-shaped webs 101 and 103 thus become oblate in shape with a smaller diameter. The tension of the rubbed oblate strip-shaped webs 101 and 103 in the longitudinal direction is effectively increased. Consequently, the fibrous webs do not stick together when being spread on the webs. The operation of the vertical corrugated fiberfill forming machine can be smooth. However, the transversal friction conveying belt device 400 is not the primary characteristic of the present application but a conventional device. The configuration of the transversal friction conveying belt device 400 will not be described herein in detail.

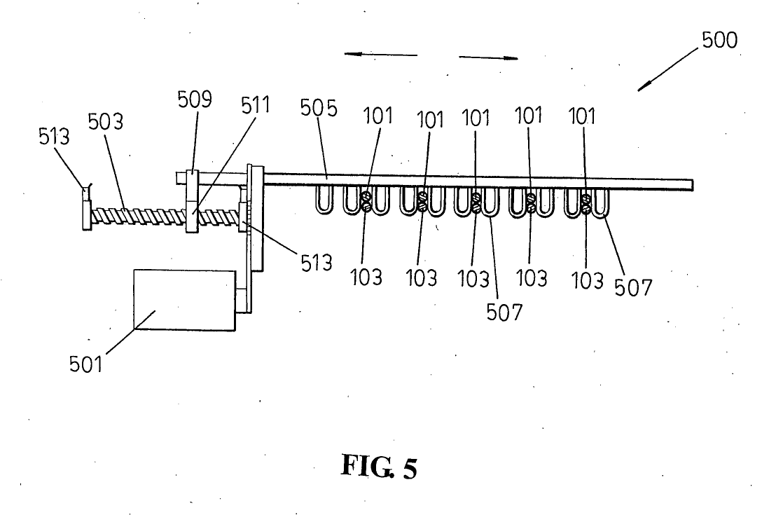

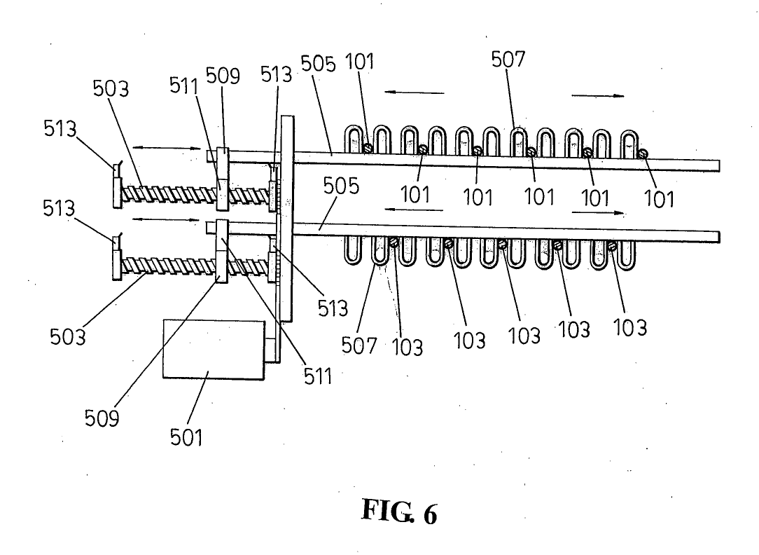

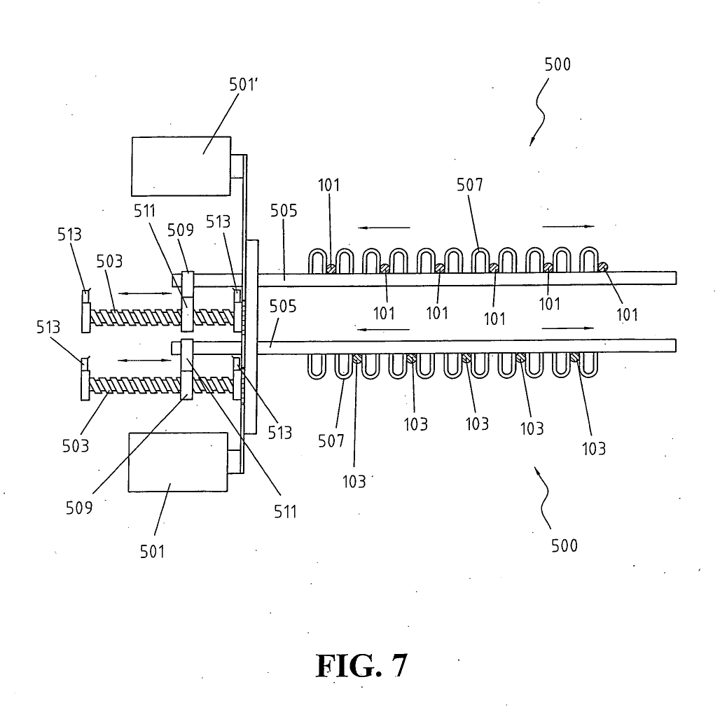

The rubbed continuous and separated strip-shaped webs 101 and 103 are passed through another set of reciprocating devices 500 to make the separated strip-shaped webs 101 and 103 become folded in parallel or irregularly and displaced in a reciprocating motion. Referring to FIGS. 2 and 5, by the setting of the reciprocating movement of the reciprocating devices 500, the strip-shaped webs 101 and 103 are continuous and are arranged in different types of curves/patterns. As shown in FIG. 5, the reciprocating devices 500 primarily use a motor 501 to provide power to drive a transversal screw rod 503. A horizontal screw rod 505 is positioned to be parallel with the screw rod 503. A number of guiding rings 507 are disposed on the screw rod 505 and separated from one another by the same distance. After being lapped in parallel with respect to each other, the upper and lower strip-shaped webs 101 and 103 pass through the space between the guiding rings 507 such that the strip-shaped webs 101 and 103 lapped in parallel with respect with each other can be separated by a constant distance. The screw rods 505 and 503 are connected by a connecting rod 509 having one fixed end engaged with the screw rod 505 and another threaded sleeve 511 engaged with the screw rod 505. When the motor 501 drives the screw rod 503 to rotate, the threaded sleeve 511 of the connecting rod 509 drives the horizontal screw rod 505 to displace horizontally. Moreover, a fine-tuning switch 513 is located at the positioning point on each side of the screw rod 503. When the connecting rod 509 displaces to the positioning point, the fine-tuning switch 513 is triggered to rotate the motor 501 in the opposite direction, such that the screw rod 505 can displace horizontally in the direction opposite to the location of the fine-tuning switch 513 at the positioning point on the other side. Such a horizontal reciprocating displacement can bring the overlapped strip-shaped webs 101 and 103 to be arranged in a curved pattern, such as an S-curve. However, when the reciprocating device 500 is fixed, the strip-shaped webs 101 and 103 are arranged in a straight line. Further, when said device is composed of two sets of reciprocating devices 500 disposed one above the other and driven by a single motor 501, as shown in FIG. 6, the motor 501 operates together with gears which have the identical gear ratio and are installed on a screw rod 503 of two reciprocating devices 500 respectively. In the light of the aforesaid arrangement, the two reciprocating devices 500 can be moved in an opposite direction at the same speed reciprocally, and the two strip-shaped webs 101 and 103 fed into the reciprocating devices 500 could thereby form various types of arrangement, such as an “8”-shape, diamond-like or cross-lapping arrangement with regular curves. On the contrary, when the two reciprocating devices 500 are driven by a single motor 501, but the motor 501 operates together with gears which have a different gear ratio, it results in the two reciprocating devices 500 moving in opposite directions at the different speeds, and the two strip-shaped webs 101 and 103 fed into the reciprocating devices 500 could thereby form a cross-lapping arrangement with irregular curves. Likewise, the movement of the two reciprocating devices 500 can also be controlled by using different motors 501 and 501′ at different speeds ratio, as shown in FIG. 7, leading to the two reciprocating devices 500 moving in opposite directions at the different speed, and the two strip-shaped webs 101 and 103 fed into the reciprocating devices 500 could thereby form a cross-lapping arrangement with irregular curves. The strip-shaped webs 101 and 103 could be single-layered, multiple-layered, folded in parallel with respect to each other, or folded irregularly, depending on the density requirements of the fibrous pad 900. Said reciprocating devices 500 can be arranged to be multiple sets of reciprocating devices 500 arranged in parallel, such that the strip-shaped webs 101 and 103 are arranged in various types of pattern. The techniques and means utilized in the application are the same as the principle described above and thus fall into the scope and spirit of the present application. The configuration of the reciprocating device 500 is not the primary characteristic of the present application and is a conventional application. The configuration of the reciprocating devices will not be described herein in detail.

With the foregoing process, a special fibrous pad 900 of the present application is obtained. The fibrous pad has a combination and distribution of different densities along the transversal cross section and is vertically corrugated in the longitudinal cross section. The high and low densities of the fibrous pad 900 can be distributed depending on the requirements. That is, the number of layers of the folded strip-shaped webs 101 and 103 and the types of the arrangement pattern of the strip-shaped webs 101 and 103 can be changed for different applications of use. For example, when the fibrous pad is used as a filter material for gas or liquid, the area of the high-density layer should be minimized and the area of the low-density layer should be maximized to increase the porous area of the low-density layer and decrease the pressure drop. The high-density layer is used to reinforce the structure of the fibrous pad. When the fibrous pad is used as a protecting pad, the area of the high-density layer should be maximized to increase the supporting strength of the fibrous pad, and the area of the low-density layer should be minimized and only provide air permeability.

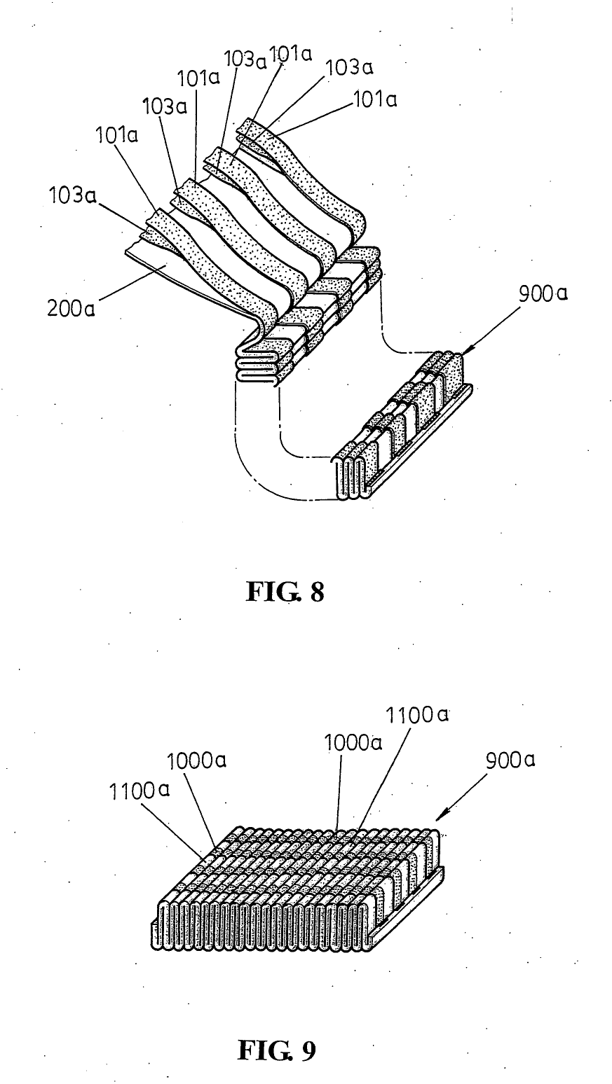

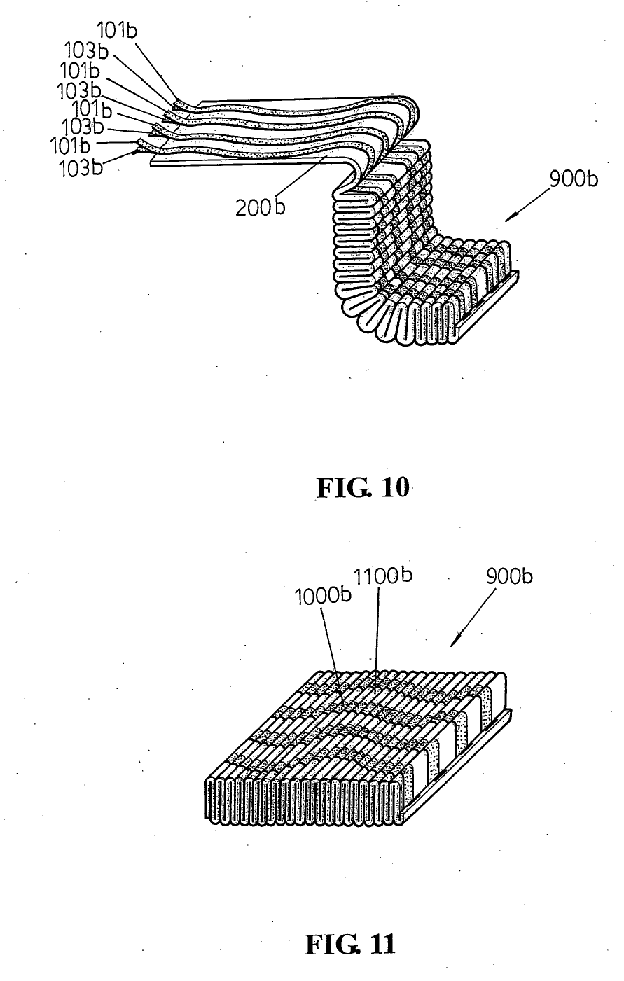

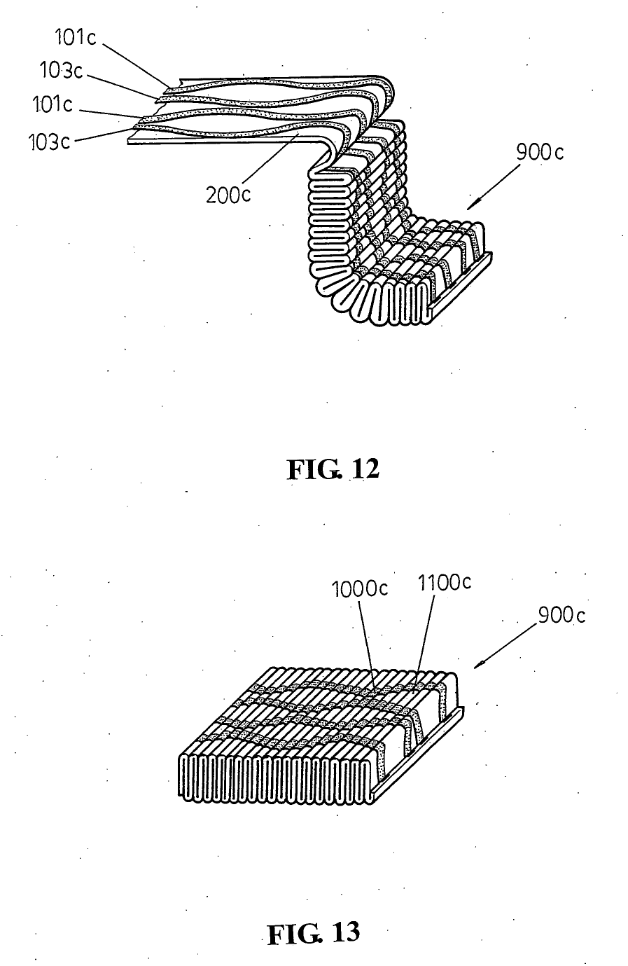

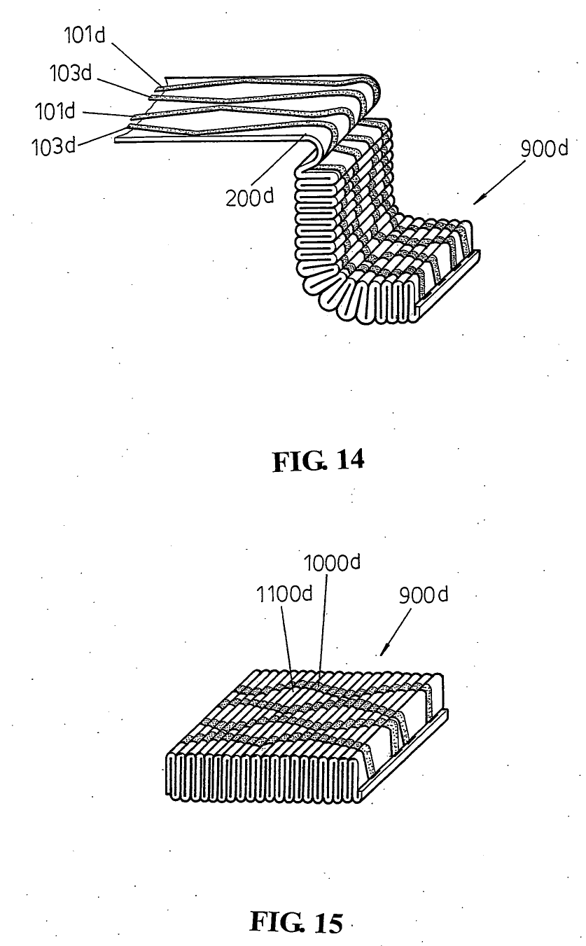

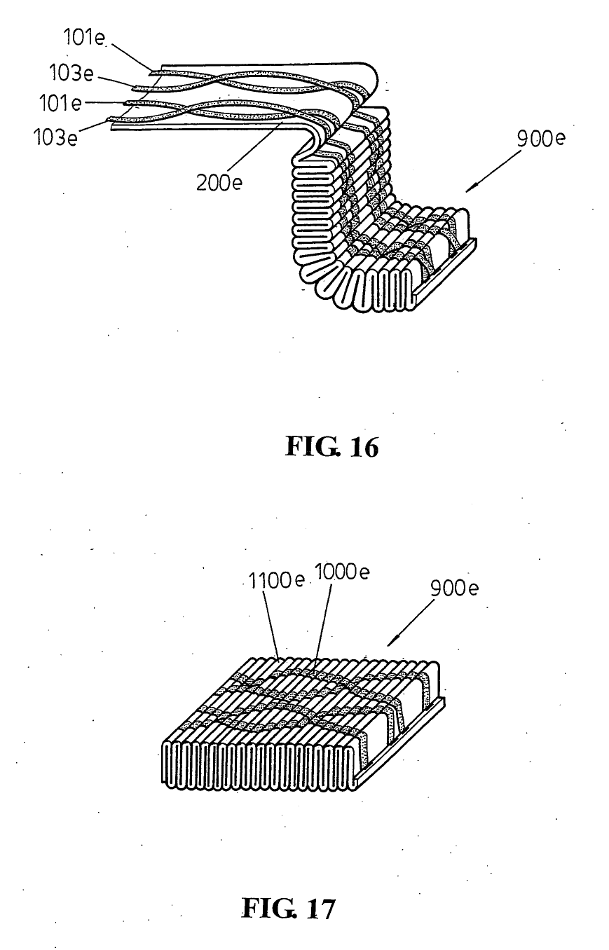

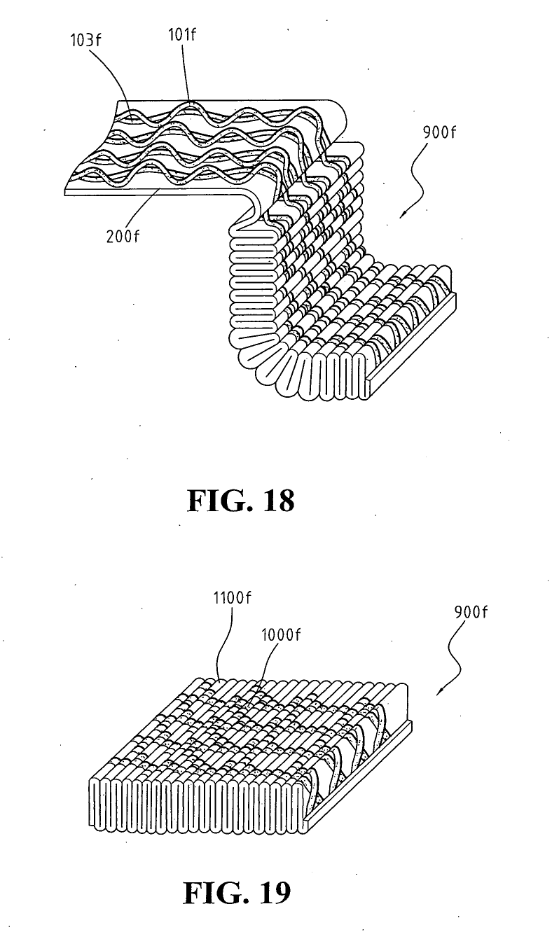

To achieve the foregoing objectives, the present application provides a special configuration of fibrous pad 900 having a combination and distribution of different densities. With reference to FIGS. 8 to 19, the sliced upper and lower strip-shaped webs 101 and 103 are spread and folded on a smooth fibrous web 200, and then vertically corrugated to form the fibrous pad 900 of the present application, as schematically shown in the drawings. FIG. 8 shows that the strip-shaped webs 101a and 103a are folded in parallel by means of a stationary reciprocating device 500 as shown in FIG. 5. The strip-shaped webs 101a and 103a are spread on the smooth fibrous web 200a in a straight-line pattern to form the vertical corrugated fibrous pad 900a as depicted in FIG. 9. FIG. 10 shows the strip-shaped webs 101b and 103b folded in parallel with respect to each other by using a reciprocating device 500 depicted in FIG. 5. The strip-shaped webs 101b and 103b are spread on the fibrous web 200b in an S-curve pattern to form the vertically corrugated fibrous pad 900b shown in FIG. 11. FIG. 12 illustrates that upper and lower strip-shaped webs 101c and 103c are displaced opposite each other at the same speed by means of the reciprocating motion of the reciprocating devices 500, as shown in FIG. 6. The strip-shaped webs 101c and 103c are spread on the fibrous web 200c in an “8”-shaped pattern to form the vertically corrugated fibrous pad 900c shown in FIG. 13. FIG. 14 discloses two strip-shaped webs 101d and 103d are displaced opposite each other at the same speed by means of the reciprocating motion of the reciprocating devices 500, as shown in FIG. 6. The strip-shaped webs 101d and 103d are spread on the fibrous web 200d in a diamond-like pattern to form the vertically corrugated fibrous pad 900d shown in FIG. 15. FIG. 16 discloses two strip-shaped webs 101e and 103e are displaced opposite each other at the same speed by means of the reciprocating motions of the reciprocating device 500, as shown in FIG. 6. The strip-shaped webs 101e and 103e are spread on the fibrous web 200e in a cross-lapping manner with regular curves to form the vertically corrugated fibrous pad 900e shown in FIG. 17. FIG. 18 discloses two strip-shaped webs 101f and 103f displaced opposite each other at a different speed by using a single motor 501 to operate together with the two screw rods 503 with a different gear ratio of the reciprocating device 500, as shown in FIG. 6, or by using a different motor 501 and 501′ with a different speed to control the two reciprocating devices 500 respectively, as shown in FIG. 7. The strip-shaped webs 101f and 103f are spread on the fibrous web 200f in a cross-lapping manner with irregular curves to form the vertically corrugated fibrous pad 900f shown in FIG. 19. The strip-shaped webs 101a, 103a, 101b, 103b, 10c, 103c, 101d, 103d, 101e , 103e, 101f and 103f, and the smooth fibrous webs 200a, 200b, 200c, 200d, 200e and 200f are corrugated to form fibrous pads 900a, 900b, 900c, 900d, 900e and 900f. The areas of the fibrous webs 200a, 200b, 200c, 200d, 200e and 200f on which the strip-shaped webs 101a, 103a, 101b, 103b, 101c, 103c, 101d, 103d, 101e, 103e, 101f and 103f are arranged and spread are the high-density layers 1000a, 1000b, 1000c, 1000d, 1000e, 1000f. The layers of the fibrous webs 200a, 200b, 200c, 200d, 200e and 200f on which the strip-shaped webs 101a, 103a, 101b, 103b, 101c, 103c, 101d, 103d, 101e, 103e, 101f and 103f are not spread are the low-density layers 1100a, 1100b, 1100c, 1100d, 1100e and 1100f. Depending on the actual density needed and the requirements for the fibrous pad, the strip-shaped webs 101 and 103 described above could be spread and overlapped on the smoother fibrous web 200 in an overlapping manner or in a different manner. At the same time, as described above, the strip-shaped webs 101 and 103 could also be one or more layered continuous fibrous webs that are sent to at least one reciprocating device 500 to be arranged and spread to form different types of pattern for the different numbers of layers and thicknesses needed. Therefore, in accordance with the present application, the variations in the density of the fibrous pad in the vertical direction can be changed and adjusted for different uses.

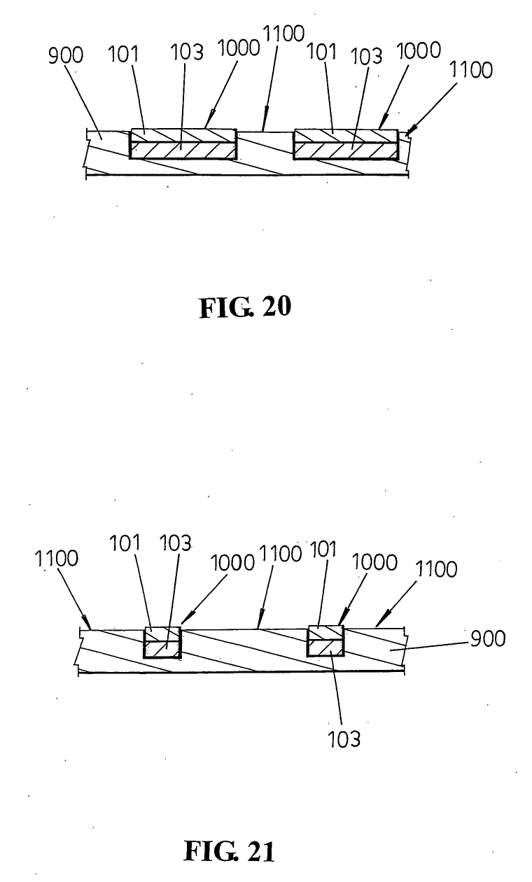

From foregoing description, if viewed from the mechanical direction (MD, longitudinal), the continuous vertical corrugated structure of the corrugated fibrous pad 900 in accordance with the present application can provide structural forces in the longitudinal, transversal and vertical directions. If viewed from the transversal cross section, the variation in the density of the fibrous pad in accordance with the present application is illustrated in FIGS. 20 and 21. The distribution of the density and the proportions that the layers of different densities occupy on transversal areas could be varied depending on the uses of the fibrous pad. As shown in FIG. 20, when the fibrous pad of the present application is used as a backing material for protection, the high-density layer 1000 must be maximized and the low-density layer 1100 must be minimized. Consequently, the strip-shaped webs 101 and 103 folded in parallel with respect to each other are spread and folded on the high-density layer 1000 of the smooth fibrous web 200. The transversal area that is occupied by the strip-shaped webs 101 and 103 on the fibrous pad 900 should be increased accordingly. Therefore, with the supporting strength provided by the high-density layer 1000, the capability of the fibrous pad to resist compression is enhanced. The low-density layer 1100 only provides the function of air permeability or of a bridge between the structures of the fibrous webs. On the contrary, as depicted in FIG. 21, when the fibrous pad in accordance with the present application is used as a filtering material, the low-density layer 1100 must be maximized and the high-density layer 1000 must be minimized. Consequently, the strip-shaped webs 101 and 103 folded in parallel with respect to each other are spread and folded on the high-density layer 1000 of the smooth fibrous web 200. The transversal area that is occupied by the strip-shaped webs 101 and 103 on the fibrous pad 900 should be decreased accordingly. Consequently, with the increase of the area of the low-density layer 1100, the porous area is effectively increased and the pressure drop is decreased to provide the function of filtering by using the low-density layer 1100.

Referring to FIGS. 9, 11, 13, 15, 17 and 19, when viewed from the surface or in the inner layers of the fibrous pad 900a, 900b, 900c, 900d, 900e and 900f of the present application, the high-density layers 1000a, 1000b, 1000c, 1000d, 1000e and 1000f are arranged regularly in a straight-line pattern along the mechanical direction, so as to be arranged in a pattern constituted by straight lines, S-curves, “8”-shaped patterns, or diamond-like patterns, or in a cross-lapping manner with regular or irregular curves. With regard to the high-density layers 1000a, 1000b, 1000c, 1000d, 1000e and 1000f formed by such arrangements, the supporting strengths of theses high-density layers are different on the basis of the density combination and distribution formed by the width and thickness (the number of layers) of the fibrous webs. Therefore, the value of the supporting strength could be changed to meet the practical requirements. The fibrous pad could be applied depending on the needs for various supporting strengths and air permeabilities.

Based on the requirements in manufacturing the fibrous pad products, in addition to slicing and folding two single-layered fibrous webs 100 and 200, the fibrous pad 900 described above can also be formed by following manufacturing processes: the multiple smooth fibrous webs 100 provided by multiple sets of carding machine are sliced and then bonded to a single-layered fibrous web 200 below; a single smooth fibrous web 100 is sliced and then bonded to a single-layered fibrous web 200 below; multiple smooth fibrous webs 100 are sliced and then bonded to multiple lower smooth fibrous webs 200; a single smooth fibrous web 100 is sliced and then bonded to multiple lower fibrous webs 200; etc. With such combinations and by increasing the number of machines used in the manufacturing process described above, after the spread and folded fibrous web combinations 600 are formed by the corrugated forming machine 800, the density of the fibrous pad is varied to provide fibrous pads for different uses. However, the design of overlapping multiple webs can use the same technical characteristics as the foregoing embodiments and thus fall into the scope defined in the claims of the present application.

To further understand the substantive contents of the present application, three embodiments of different implementations follow.

### Embodiment I

Twenty-five strip-shaped webs 101 and 103 having a density of 1 oz/yd² are spread on a smooth fibrous web 200 having a density of 0.5 oz/yd². Each of the strip-shaped webs 101 and 103 has a width of two inches, and the fibrous web 200 has a width of 100 inches. The strip-shaped webs 101 and 103 are separated in parallel with respect to each other with a distance of two inches. The combined fibrous web 600 is fed into a vertical corrugated forming machine 800 to form a porous fibrous pad 900 having a width of 100 inches, a thickness of two inches, a high-density layer 1000 having a density of 1.5 lb/ft³ and a low-density layer 1100 having a density of 0.5 lb/ft³. When viewed from the surface layers of the fibrous pad 900 in the mechanical direction, the high- and low-density layers are bonded to form a pattern consisting of multiple continuous straight lines. When viewed along the transversal section of the fibrous pad 900, each of the high-density layers 1000 having a width of two inches is adjacent to a low-density layer 1100 having a width of two inches.

### Embodiment II

Fifty lapped strip-shaped webs 101 and 103 having a density of 0.67 oz/yd² are spread on a smooth fibrous web 200 having a density of 0.5 oz/yd². Each of the strip-shaped webs 101 and 103 has a width of 1.5 inches, and the fibrous web 200 has a width of 100 inches. The strip-shaped webs 101 and 103 are separated in parallel with respect to each other by a distance of 0.5 inches. The adjacent continuous strip-shaped webs 101 and 103 displace in a reciprocating motion in the transversal direction when the strip-shaped webs 101 and 103 are spreading on the fibrous web 200. Consequently, the strip-shaped webs 101 and 103 form an S-curve pattern on the fibrous web 200 to obtain a bonded fibrous web 600. The combined fibrous web 600 is then fed into a vertical corrugated forming machine 800 to form a porous fibrous pad 900 having a width of 100 inches, a thickness of two inches, a high-density layer 1000 having a density of 1.17 lb/ft³ and a low-density layer 1100 having a density of 0.5 lb/ft³. When viewed from the surface layers of the fibrous pad 900 in the mechanical direction, the high- and low-density layers form patterns constituting multiple continuous S-curves on the fibrous web. When viewed along the transversal direction of the fibrous pad 900, each of the high-density layers 1000 having a width of 1.5 inches is adjacent to a low-density layer 1100 having a width of 0.5 inches. The combined high- and low-density layers regularly extend 100 inches along the width of the fibrous pad.

### Embodiment III

Twenty-five lapped strip-shaped webs 101 and 103 having a density of 2 oz/yd² are spread on a smooth fibrous web 200 having a density of 0.5 oz/yd². Each of the strip-shaped webs 101 and 103 has a width of one inch, and the fibrous web 200 has a width of 100 inches. The strip-shaped webs 101 and 103 are separated from each other by a distance of three inches. The adjacent continuous strip-shaped webs 101 and 103 displace in a reciprocating motion in the transversal direction when the strip-shaped webs 101 and 103 are spreading on the fibrous web 200. Consequently, the strip-shaped webs 101 and 103 form a pattern constituted by “8”-like patterns or diamond-like patterns on the fibrous web 200 to obtain a combined fibrous web 600. The combined fibrous web 600 is then fed into a vertical corrugated forming machine 800 to form a porous fibrous pad 900 having a width of 100 inches, a thickness of 2 inches, a high-density layer 1000 having a density of 2.5 lb/ft³ and a low-density layer 1100 having a density of 0.5 lb/ft³. When viewed from the surface layers of the fibrous pad 900 in the mechanical direction, the high-density layers forms “8”-like or diamond-like patterns on the fibrous web, and the low-density layers 1100 are located in the spaces confined by the “8”-like or diamond-like patterns. When viewed along the transversal section of the fibrous pad 900, each of the high-density layers 1000 having a width of one inch may be adjacent to a high-density layer 1000 having a width of one inch, or each of the high-density layers 1000 having a width of one inch may also be adjacent to a low-density layer 1100 having a width of 0-6 inches along the structure of the regularly varied patterns.

What is claimed is:

1. A fibrous pad structure having a variable density comprising continuous strip-shaped webs that have been sliced and cut, and then arranged and spread regularly on at least one continuous smooth web in a manner of overlapping at least once, the combined fibrous webs are formed and shaped so that the fibrous pad structure has different density combinations and distributions of different widths and different numbers or layers in the transversal cross section and a continuous corrugation in the mechanical direction.

2. The fibrous pad structure in accordance with claim 1, wherein the strip-shaped fibrous webs spread and arranged on the smooth fibrous web constitute the high-density layer of the fibrous pad.

3. The fibrous pad structure in accordance with claim 2, wherein the low-density layer of the fibrous pad is the area of the smooth fibrous web on which no strip-shaped fibrous web was spread and arranged.

4. The fibrous pad structure in accordance with claim 3, wherein when the fibrous pad is used as a filtering material, in the density combination of the fibrous pad on the transversal cross section, the area of the high-density layer should be minimized, while in contrast, the area of the low-density layer should be maximized to increase the porous area of the low-density layer and decrease the pressure drop, and the high-density layer only provides structural reinforcement for the fibrous pad.

5. The fibrous pad structure in accordance with claim 3, wherein when the fibrous pad is used as a backing material for protection, in the density combination of the fibrous pad on the transversal cross section, the area of the high-density layer should be maximized to increase the supporting strength of the fibrous pad, while in contrast, the area of the low-density layer should be minimized to only provide the function of air permeability and a structural function.

6. The fibrous pad structure in accordance with claim 1, wherein the sliced strip-shaped fibrous webs are rubbed to form continuous strip-shaped fibrous webs having an oblate shape.

7. The fibrous pad structure in accordance with claim 1, wherein the strip-shaped fibrous webs are sliced to form two strip-shaped fibrous webs that are continuous and are separated from each other by a constant distance, the upper and lower strip-shaped webs are separated to form a fibrous web with upper and lower layers, and the strips on the layers remain at a constant distance from each other, and the widths of the sliced strip-shaped fibrous webs define the distance between the adjacent fibrous webs and further influence the density variation of the formed fibrous pad structure.

8. The fibrous pad structure in accordance with claim 7, wherein the strip-shaped fibrous webs are sliced and cut into double or multiple-double strip-shaped fibrous webs that are continuous and separated from each other by a constant distance.

9. The fibrous pad structure in accordance with claim 1, wherein the strip-shaped fibrous webs are spread and folded on the smooth fibrous web in an arrangement of multiple straight lines to form a corrugated vertical fibrous pad.

10. The fibrous pad structure in accordance with claim 1, wherein the strip-shaped fibrous webs are spread and folded on the smooth fibrous web in an arrangement of multiple S-curves to form a corrugated vertical fibrous pad.

11. The fibrous pad structure in accordance with claim 1, wherein the strip-shaped fibrous webs are spread and folded on the smooth fibrous web in an arrangement of “8”-shaped patterns to form a corrugated vertical fibrous pad.

12. The fibrous pad structure in accordance with claim 1, wherein the strip-shaped fibrous webs are spread and folded on the smooth fibrous web in an arrangement of diamond-like patterns to form a corrugated vertical fibrous pad.

13. The fibrous pad structure in accordance with claim 1, wherein the strip-shaped fibrous webs are spread and folded on the smooth fibrous web in a cross-lapping arrangement with regular curves to form a corrugated vertical fibrous pad.

14. The fibrous pad structure in accordance with claim 1, wherein the strip-shaped fibrous webs are spread and folded on the smooth fibrous web in a cross-lapping arrangement with irregular curves to form a corrugated vertical fibrous pad.
